(19) United States
(12) Patent Application Publication
(10) Pub. No.: US 2011/0232857 A1
(43) Pub. Date: Sep. 29, 2011

(54) Investment Casting Shell Incorporating Desiccant Material

(76) Inventors: Daniel S. McGuire, Oregon, WI (US); Eric E. Hellstrom, Tallahassee, FL (US)

(21) Appl. No.: 12/892,550

(22) Filed: Sep. 28, 2010

Related U.S. Application Data
(60) Provisional application No. 61/316,583, filed on Mar. 23, 2010.

(51) Int. Cl. B22D 23/00; B22C 9/02; B22C 9/04; B28B 7/36

(52) U.S. Cl. 164/519; 164/361; 106/38.27

(57) ABSTRACT

An investment casting method involves producing a casting shell by applying a hardenable slurry to a sacrificial pattern. To hasten the hardening of the slurry into the shell, a stucco coat including a desiccant material having a high surface area is subsequently applied to the slurry.

### CROSS REFERENCE TO RELATED APPLICATION

This case claims the benefit of provisional application 61/316,583 filed Mar. 23, 2010 and hereby incorporated by reference.

### STATEMENT REGARDING FEDERALLY SPONSORED RESEARCH OR DEVELOPMENT

### Background of the Invention

The present invention is directed to investment casting and more particularly to a composition for an investment casting shell and a corresponding method that minimizes “pattern-to-pour” cycle times.

Investment casting is commonly used to produce high-quality cast products with relatively close dimensional tolerances. Generally, an investment casting of a part is made by coating a pattern with a material that hardens to create a unitary, thin-walled, heat-resistant shell. After the shell has dried, the pattern may be removed by melting, burning or the like, permitting a pattern with undercut portions to be removed from a single piece shell without damage to the shell. In this pattern removal process, the shell is heated to at least the melting or burning point of the pattern and the pattern substrate is melted or burned away leaving only the shell and any residual substrate. The shell is then heated to a temperature high enough to flash off the residual substrate that remains in the shell. For this purpose, the pattern may be constructed of either a low melting point substrate or a combustible substrate such as, wax, polystyrene, plastic, synthetic rubber, or any other substrate as is known in the art.

After the pattern has been removed (or in some cases without the pattern being removed), the shell is filled with molten material, such as metal, which is allowed to harden in the shell. Various methods are used to introduce molten metal into shells including gravity, vacuum pressure, and centrifugal methods. Alternatively, after the pattern has been removed, small solid particles such as glass may be introduced into the shell, and subsequently heated to a molten state. The resultant molten material thereby fills the shell, and solidifies into a casting after cooling.

After the casting material has solidified, the shell is removed, for example by breaking it apart (e.g., hammering) or eroding it away (e.g., sand blasting). After the shell is removed from the casting, the casting may be further processed in a cleaning or finishing step, to reveal the finished cast part. This above investment casting process is also often referred to as lost wax, lost pattern, ceramic shell, or precision casting.

The process of forming the shell used in investment casting may involve the repeated steps of dipping the pattern in a liquid slurry, coating the dipped part with refractory material (stucco), and allowing the slurry and refractory to harden between dips. Typically shells are gradually built up to a thickness of approximately ⅛″ or more. It is not uncommon in the industry to use seven or more layers per shell. Patterns may be manually dipped or dipped using robotic manipulators or the like.

Overall, the process of shell building is time consuming because each coat of slurry (each with a corresponding coat of refractory material) must be air-dried prior to the application of subsequent coats. In many cases, shells cannot be baked at elevated temperatures for extended periods of time without compromising the integrity of the cured shell. In these cases, each cycle of dipping and air-drying may require as little as 1 to 2 hours for some patterns or as long as twenty-four to forty-eight hours for other patterns, resulting in a total time to produce a 5-layer shell that may be as short as 5 hours but may typically take several days.

The shell material must be not only sufficiently strong to resist the pressure of the molten cast material but it must also resist deformation, cracking, and/or excessive outgassing when in contact with high-temperature molten casting materials. Desirably the chemicals within the shell should not be overly reactive with the cast material. For example they should not react with the molten metal to produce oxides or scaling that will need to be removed.

U.S. Pat. No. 7,278,465, assigned to the assignee of the present invention and hereby incorporated by reference describes a method of producing shells for investment casting using a stucco that may dry the slurry faster than standard stucco and in one embodiment using a stucco that contains an amorphous mineral silicate. Such an approach can reduce the drying time of a layer of the shell substantially.

### SUMMARY OF THE INVENTION

The present invention provides a stucco that further reduces drying time by incorporating a desiccant that absorbs water over a large surface area of the desiccant material. Such water retention might normally be expected to retard drying of the shell and to create the risk of steam explosions (“steam bombs”) or steam damage to the shell or casting when the residual pattern material is flashed or the high-temperature casting materials contact water laden desiccant material. This has not proven to be the case.

Specifically the present invention provides a stucco material for use in making shells for investment casting where a pattern is coated with a colloidal silica-based slurry and the stucco coat is applied over the slurry to hasten the hardening of the slurry. In the invention the stucco material comprises no less than 1% by weight, and preferably no less than 20% by weight, of an inorganic desiccant material having a surface area in excess of 100 m² per gram.

It is one feature of at least one embodiment of the invention to greatly decrease the time required to produce a shell for investment casting. As previously discussed, the time required to produce a shell for investment casting is dependent in part on the slurry drying time. Unexpectedly, the desiccant material, despite its great water collecting properties, does not create problems with drying and/or outgassing or explosions during heat exposure.

It is one feature of at least one embodiment of the invention to provide a stucco material comprising at least one, and potentially multiple, inorganic desiccant material that may be a zeolite, activated alumina, silica gel and/or a molecular sieve material.

It is one feature of at least one embodiment of the invention to provide a stucco material that may make use of a variety of readily obtainable materials of either synthetic or naturally occurring origin.

It is one feature of at least one embodiment of the invention to provide an investment casting shell further including no less than 1% by weight, and preferably no less than 10% by weight, silica.

It is one feature of at least one embodiment of the invention to provide a casting shell having thermal properties sufficient to withstand the heat exposure associated with investment casting.

It is one feature of at least one embodiment of the invention to provide a stucco material comprising an inorganic desiccant material having a melting point above 1000° C.

It is one feature of at least one embodiment of the invention to provide a casting shell suitable for high-temperature cast materials.

It is one feature of at least one embodiment of the invention to provide an investment casting method for creating an article from a pattern in which a slurry is applied to a pattern, wherein the slurry comprises a colloidal silica and a stucco coat is applied over the slurry to hasten the hardening of the slurry into a shell, wherein the stucco coat comprises no less than 1% by weight, and preferably no less than 20% by weight, of an inorganic desiccant material having a surface area in excess of 100 m² per gram. The pattern is then replaced with a molten material, which is allowed to solidify in the shell to produce a cast article.

It is one feature of at least one embodiment of the invention to provide a stucco material suitable for conventional slurry-type shell producing techniques.

These particular objects and advantages may apply to only some embodiments falling within the claims and thus do not define the scope of the invention.

### BRIEF DESCRIPTION OF THE DRAWINGS

FIG. 1 is a depiction of the steps of creating a shell using a slurry and stucco material per the present invention; and

FIG. 2 is a flow chart showing the steps of FIG. 1 in an investment casting process.

### DESCRIPTION OF THE PREFERRED EMBODIMENT

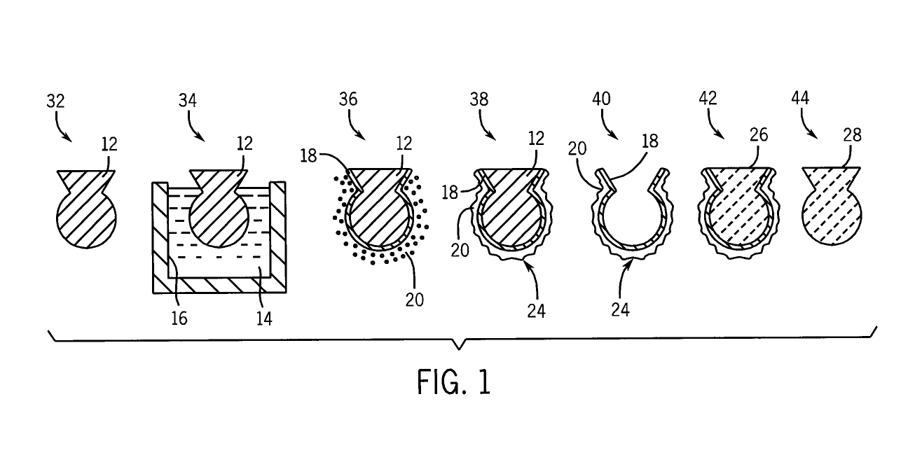

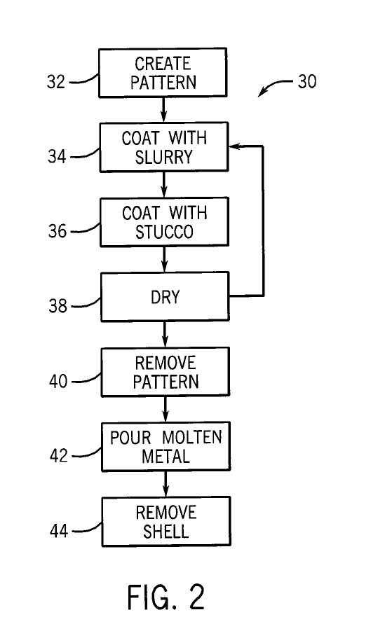

Referring to FIGS. 1 and 2, an investment casting method 30 employing the present invention is shown and illustrated. In a first step 32, a pattern 12 is created, whose outer shape defines the outer shape of a desired casting. The pattern 12 may provide for a wide variety of different cast articles including articles with undercut portions and is preferably formed from a material readily removed from an investment shell under elevated temperatures. For example the pattern 12 may be formed from wax, polymer foam, paper products, etc.

At a succeeding step 34, the outer shape of pattern 12 may receive a slurry coat 18 for example by dipping the pattern 12 in the slurry material 14 contained in a vat 16. Alternately, the slurry coat 18 may be poured, brushed or hand packed on the pattern, for example. Slurry material 14 may comprise a liquid mixture of ceramic materials, including colloidal silica, suspended in water, as is known in the art.

At a succeeding step 36, the pattern 12 may be coated with a stucco material 20 for example by submerging the pattern 12 into a fluidized stucco material 20. Alternatively the stucco material 20 may be sprinkled, sprayed, brushed or hand packed on the pattern, for example. The stucco material 20 may be formed of a composition of dry refractory powder comprising no less than 1% by weight, and preferably no less than 20% by weight, of an inorganic desiccant material having a surface area in excess of 100 m² per gram, is herein illustrated, such as a zeolite, activated alumina, silica gel, and/or a molecular sieve material, the composition of which will be further discussed herein.

At a succeeding step 38, the slurry coat 18 and the stucco material 20 are dried to remove water from the slurry material 14, resulting in the formation of a single-layer, hardened shell 24 surrounding the pattern 12. The slurry coat 18 and the stucco material 20 may be passively air dried, or the drying process may be facilitated by some mechanical or thermal means known in the art.

To create a hardened shell 24 of sufficient integrity to withstand the prolonged heat exposure associated with investment casting, it may be necessary to add additional layers to the hardened shell 24. Accordingly, steps 34 through 38 may be repeated as necessary to produce a hardened shell 24 comprising multiple layers of slurry coat 18 and stucco material 20. For example, it is not uncommon to produce a hardened shell 24 comprising seven layers of slurry coat 18 and stucco material 20. Further, the number of layers comprising the hardened shell 24 may be determined by the thermal properties of the metal to be cast in the shell 24.

At a succeeding step 40, the pattern 12 is removed from the shell 24. In some cases the pattern 12 and shell 24 are exposed to heat sufficient to evacuate the pattern 12 by means of combustion or melting of the pattern 12. The shell 24 will then be subjected to temperature high enough to flash off any residual pattern material. The evacuation of the pattern 12 will render shell 24 hollow, having an inner surface complementary to the outer surface of the pattern 12. The exposure to heat in step 40 may also result in curing of hollow shell 24.

At a succeeding step 42, molten metal 26 is poured into the hollow shell 24, wherein the metal 26 is allowed to cool and solidify into casting 28. In some situations, the pouring of molten metal 26 will occur concurrently with the evacuation of the pattern 12 in step 40, requiring that the temperature of the molten metal 26 is sufficiently high to evacuate the pattern 12.

In a final step 44, the shell 24 is removed from the casting 28 by a means suitable for removing the shell 24 without damaging casting 28, such as hammering or abrasive blasting for example.

Overall, the method 30 and the composition of stucco material 20 allow the user to create a shell 24, directed to investment casting, with a substantial reduction in the drying time associated with step 38, while simultaneously preventing increased risk of shell deformation, cracking, outgassing, steam bombs or explosions during heat exposure.

In addition, a benefit of an illustrated embodiment is to reduce the time required for the liquid slurry coat 18 to dry and harden. As it is known in the art, multiple applications of liquid slurry coat 18 and stucco material 20 are often required to achieve a shell of desired thickness to withstand the casting process. A layer of liquid slurry coat 18 must dry and harden before a subsequent layer may be applied. Accordingly, the time required for the liquid slurry coat 18 to dry, and thereby the rate at which layers of liquid slurry coat 18 and stucco material 20 may be applied, i.e. “cycle time”, significantly influences the time required to construct the shell. Utilizing conventional methods, cycle times ranging from 1 to 2 hours up to 24 to 48 hours are common thereby requiring at least 5 hours and often several days to construct a shell consisting of five layers. Utilizing the presently illustrated composition of stucco material 20, comprising an inorganic desiccant material having a surface area in excess of 100 m² per gram, such as zeolite, activated alumina, silica gel, and/or a molecular sieve material, the cycle time may be reduced to 15-20 minutes thereby requiring less than two hours to produce a five layer shell. This reduction in shell production time directly correlates to a decrease in the “pattern-to-pour” cycle time at a significant cost savings.

Another benefit of an illustrated embodiment is that the stucco material 20 will not alter the pH of the colloidal silica located in the slurry coat 18. The colloidal silica, which is a colloid of amorphous silica particles in a suspension of ionized water, is present as a liquid binder providing a vehicle for the other dry materials to mix into. The colloidal silica acts as a fluxing agent at high temperatures. Notably, colloidal silica has a pH of about 9. It is known in the art that stucco material additives of varying alkalinities, which induce a pH fluctuation in the colloidal silica located in the slurry coat 18 decrease slurry drying times. Examples of such additives may include magnesium containing compounds and calcium containing compounds. However, pH fluctuation in colloidal silica may also result in slurry coat 18 assuming a gel like consistency, and by way of contamination may potentially render an entire vat 16 of slurry material 14 unusable. Accordingly, the stucco material 20 of the illustrated embodiment reduces the potential for colloidal silica gelling by means of maintaining the pH of the colloidal silica located in the slurry material 14 and slurry coat 18, without fluctuation.

In addition, the illustrated embodiments provide the additional benefit of facilitating shell removal during step 44, once the molten metal has cooled and solidified into casting 28. The composition of stucco material 20 results in the production of a shell 24 that breaks into larger pieces than traditional investment casting shells. These larger pieces are more easily and quickly removed from the casting 28, thereby reducing the labor required during step 44.

### Example I

To achieve the above-noted benefits, a composition of the stucco material 20 comprising no less than 1% by weight, and preferably no less than 20% by weight, of an inorganic desiccant material having a surface area in excess of 100 m² per gram is herein illustrated. At least one formulation of such a composition is as follows.

Molecular sieve 2000 16×40 mini beads at about 40% composition by weight,

DD-6 activated alumina at about 40% composition by weight, and

30-50 mesh fused silica at about 20% composition by weight can be used to construct a stucco material with the benefits discussed above.

The molecular sieve is at least a partially crystalline aluminosilicate having a three-dimensional interconnecting network of silica and alumina tetrahedra. The removal of water from this network by means of heating produces uniform cavities that selectively adsorb molecules of a specific size. The molecular sieve 2000 16×40 mini beads of the illustrated embodiment, are commercially available from UOP, A Honeywell Company, and preferably exhibit a melting point of about 1100° C. and have a 16×40 Tyler Mesh size.

The activated alumina is a porous and partially amorphous form of aluminum oxide (Al₂O₃) of high surface area that adsorbs liquids without a substantial change in form. Activated alumina has a melting point of approximately 2045° C., a boiling point of approximately 2980° C. and a surface area of approximately 200 m² per gram. Following an initial absorption of water, activated alumina may be returned to its original adsorption efficiency by heating to a temperature between 177-316° C. The DD-6 activated alumina of the illustrated embodiment is commercially available from Delta Absorbents, has a 14×28 Tyler Mesh size, and a surface area in excess of 300 m² per gram.

The fused silica is a non-crystalline amorphous form of silicon dioxide (SiO₂). Fused silica is a low thermal expansion material, and accordingly is resistant to significant thermal shock. The material is also chemically inert with respect to the remaining components of the stucco material 20 as well as the slurry material 14 components, and will not alter the pH of the colloidal silica in the slurry material 14. The fused silica of the illustrated embodiment is commercially available from Minco, Inc., has a 30/50 mesh size, a melting point of approximately 1715° C., a density of approximately 2.18-2.20 g/cc, and a purity of at least 99.7% SiO₂.

### Example II

In some embodiments, the shell may require exposure to prolonged periods of high heat. Under such exposure, one formulation of the stucco composition material with the benefits discussed may be:

Molecular sieve 2000 16×40 mini beads at about 20% composition by weight,

DD-6 activated alumina at about 40% composition by weight, and

30/50 mesh tabular alumina at about 40% composition by weight.

Tabular alumina (Al₂O₃) is a non-reactive compound produced by sintering ball-formed calcined alumina, then crushing the tabular alumina balls. It typically exhibits high density, low porosity, a high mechanical strength and a melting point of approximately 2000° C. The tabular alumina of this example is 30/50 mesh. In accordance with these properties, the addition of tabular alumina and the subtraction of fused silica thereby results in a stucco material composition ideal for withstanding prolonged periods of increased heat exposure.

### Example III

An alternative formulation of a stucco composition intended to achieve the above-noted benefit of exposure to prolonged period of high heat may be:

DD-6 activated alumina at about 50% composition by weight, and

30/50 mesh tabular alumina at about 50% composition by weight.

In accordance with these properties, the subtraction of molecular sieve as well as the increase in activated alumina and tabular alumina, relative to the formula expressed in Example II, thereby results in a stucco material composition ideal for withstanding prolonged periods of increased heat exposure.

To achieve the above-noted benefits, a composition of the stucco material 20 comprising no less than 1% by weight, and preferably no less than 20% by weight, of an inorganic desiccant material having a surface area in excess of 100 m² per gram is herein illustrated. At least one formulation of such a composition is as follows.

In some embodiments a composition of the stucco material 20 may additionally contain other materials, providing that the stucco material 20 maintains a composition having no less than 1% by weight, and preferably no less than 20% by weight, of an inorganic desiccant material having a surface area in excess of 100 m² per gram.

The general stucco material formula may be adjusted to compensate for the chemical and thermal characteristics of the molten metal being cast, as well as differing periods of heat exposure associated with both the pattern removal during step 40 and molten metal addition during step 42. Accordingly, by means of adjusting the percentages of the components discussed above, alternate compositions are considered well within the scope of this invention. Furthermore, the substitution or additions of alternate components described herein were derived with the corresponding benefits discussed. Such components may include at least one of: a zeolite, silica gel, activated alumina, and tabular alumina. A zeolite of the illustrated embodiment would preferably be a highly porous crystalline aluminosilicate with a surface area of from 100 to 800 m² per gram. A silica gel of the illustrated embodiment would preferably be a highly porous, amorphous silicate with a surface area of approximately 800 m² per gram and a melting point of approximately 1000° C.

While generally the term molecular sieve relates to zeolites, that is, aluminosilicates made up of SiO₄ and AlO₄ tetrahedron that share corners forming a framework of hollow cages, molecular sieve can also be used to describe materials that have crystal structures like zeolites, i.e. made up of a framework structure of hollow cages, but are technically not zeolites because they contain atoms other than silicon and aluminum in the structural tetrahedron. Examples of such atoms are P in addition to Si and Al.

In addition to use with colloidal silica-based slurry, it is believed that the above disclosed stucco formulas may exhibit similar benefits when used in conjunction with an ethyl silicate-based slurry. Use of ethyl silicate-based slurry may further require the inclusion of ammonia, in addition to those components previously discussed. Accordingly, those shells incorporating an ethyl silicate-based slurry are considered well within the scope of this invention.

Although the invention is described with reference to an illustrated embodiment, it should be appreciated by those of ordinary skill in the art that various modifications are well within the scope of the invention. Therefore, the scope of the invention is to be determined by reference to the following claims:

What we claim is:

1. An investment casting shell for the casting of high-temperature molten materials comprising no less than 1% by weight of an inorganic desiccant material having a surface area in excess of 100 m² per gram.

2. The investment casting shell of claim 1 wherein the inorganic desiccant material is selected from the group consisting of a zeolite, activated alumina, silica gel, and a molecular sieve material.

3. The investment casting shell of claim 1 wherein the inorganic desiccant material comprises multiple inorganic desiccant materials selected from the group consisting of a zeolite, activated alumina, silica gel, and a molecular sieve material.

4. The investment casting shell of claim 1 further comprising no less than 20% by weight of the inorganic desiccant material.

5. The investment casting shell of claim 1 further including no less than 1% by weight of silica.

6. The investment casting shell of claim 1 further including no less than 10% by weight of silica.

7. The investment casting shell of claim 1 wherein the inorganic desiccant material has a melting point above 1000° C.

8. A stucco material for use in investment casting in which a pattern is coated with a slurry and the stucco material is applied over the slurry to hasten the hardening of the slurry, a stucco material comprising no less than 1% by weight of an inorganic desiccant material having a surface area in excess of 100 m² per gram.

9. The stucco material of claim 8 wherein the inorganic desiccant material is selected from the group consisting of a zeolite, activated alumina, silica gel, and a molecular sieve material.

10. The stucco material of claim 8 comprising no less than 20% by weight of the inorganic desiccant material.

11. The stucco material of claim 8 wherein an investment casting shell comprising the slurry and stucco material further includes no less than 1% by weight of silica.

12. The investment casting shell of claim 11 comprising no less than 10% by weight of silica.

13. The stucco material of claim 8 wherein the inorganic desiccant material has a melting point above 1000° C.

14. An investment casting method for creating an article from a pattern, the method comprising:
applying a slurry to the pattern, wherein the slurry comprises a colloidal silica;
applying a stucco coat over the slurry to hasten the hardening of the slurry into a shell, wherein the stucco coat comprises no less than 1% by weight of an inorganic desiccant material having a surface area in excess of 100 m² per gram;
replacing the pattern with a molten material; and
allowing the molten material to solidify in the shell to produce the article.

15. The investment casting method of claim 14 wherein the inorganic desiccant material is selected from the group consisting of a zeolite, activated alumina, silica gel, and a molecular sieve material.

16. The investment casting method of claim 14 wherein the inorganic desiccant material comprises multiple inorganic desiccant materials selected from the group consisting of a zeolite, activated alumina, silica gel, and a molecular sieve material.

17. The investment casting method of claim 14 wherein the stucco coat comprises no less than 20% by weight of an inorganic desiccant material.

18. The investment casting method of claim 14 wherein the shell further includes no less than 1% by weight of silica.

19. The investment casting method of claim 14 wherein the shell further includes no less than 10% by weight of silica.

20. The investment casting method of claim 14 wherein the inorganic desiccant material has a melting point above 1000° C.
